(19) United States
(12) Patent Application Publication
(10) Pub. No.: US 2005/0105511 A1
(43) Pub. Date: May 19, 2005

(54) Method and system for establishing a media session

(75) Inventor: Miikka Poikselka, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/817,992

(22) Filed: Apr. 6, 2004

(30) Foreign Application Priority Data
Nov. 14, 2003 (FI) 20031659

(51) Int. Cl. H04L 12/66

(52) U.S. Cl. 370/352

(57) ABSTRACT

Upon receiving an initial media session invitation request from a first media communication device (UEA), such as originating user equipment or an originating media communication server, a second media communication device (PoC server), such as a media communication server responds to by sending a media inactivity indication to the first media communication device and setting the media inactive, while continuing the media session establishment at the same time. When the second media communication device receives a final response or a response from destination user equipment, the second media communication device sends a media activity indication to the first media communication device, thereby indicating that the media are now active. Standard messages can be used in their original context, while the use of the media inactivity and media activity control during the session establishment enables a controlled way to pre-establish the originating leg of the media session before the destination leg of the media session has been completed. The first media communication device will start sending media traffic only in a controlled manner either after receiving the media activity indication or after receiving a specific floor control command

### FIELD OF THE INVENTION

The present invention relates to controlling of media sessions in communication systems.

### BACKGROUND OF THE INVENTION

Particularly in the third generation (3G) mobile communications systems, a public land mobile network (PLMN) infrastructure may be logically divided into a core network (CN) and an access network (AN) infrastructures, as illustrated in FIG. 1. The access network AN may be called base station subsystem (BSS) for GSM and radio network subsystem (RNS) or radio access network (RAN) for UMTS. In the technical specifications of third generation partnership project (3GPP), the core network CN is logically divided into a circuit switched (CS) domain, a packet switched (PS) domain and an IP multimedia subsystem (IMS). The CS domain refers to the set of all the CN entities offering “CS type of connection” for user traffic as well as all the entities supporting the related signalling. A “CS type of connection” is a connection for which dedicated network resources are allocated at the connection establishment and released at the connection release. A “PS type of connection” transports the user information using packets so that each packet can be routed independently from the previous one. Example of the PS domain may be the GPRS (General Packet Radio Service), and the typical entities may include serving GPRS support node (SGSN) and gateway GPRS support node (GGSN).

The IP multimedia subsystem comprises all CN elements for provision of multimedia services. The IP multimedia subsystem IMS utilizes the PS domain to transport multimedia signalling and bearer traffic.

IETF and the 3rd Generation Partnership Project (3GPP) have defined Session Initiation Protocol (SIP) session flows which are used in IP communication systems. Example of the IP communication system is IP Multimedia Subsystem (IMS). Thus, a call control protocol for use in the IP Multimedia (IM) Core Network (CN) subsystem is based on the (SIP), and the associated Session Description Protocol (SDP). The core SIP functionality is described in RFC 3261 (Request for Comments) and overall IMS architecture is specified in the technical specifications 3GPP TS 23.228 V6.3.0 (2003-09), 3GPP TS 24.228 V5.6.0 (2003-09), and 3GPP TS 24.229 V6.0.0 (2003-09), for example.

In a voice communication with “push-to-talk, release-to-listen” feature, a call is based on the use of a pressel (PTT, push-to-talk switch) in a telephone as a switch: by pressing a PTT the user indicates his desire to speak, and the user equipment sends a service request to the network. Alternatively, a voice activity detector (VAD) or any suitable means can be used instead of the manual switch. The network either rejects the request or allocates the requested resources on the basis of predetermined criteria, such as the availability of resources, priority of the requesting user, etc. At the same time, a connection is established also to a receiving user, or users in the case of group communication. After the voice connection has been established, the requesting user can talk and the other users can listen to. When the user releases the PTT, the event is detected in the network, and the resources are released and/or talk item is granted to another user. Thus, the resources are reserved only for the actual speech transaction or speech item, instead of reserving the resources for a “call”.

Similar communication method is now becoming available also in public mobile communications systems. New packet-mode (e.g. IP) voice and data services are being developed for cellular networks, especially in the GSM/GPRS/UMTS network evolution. In some approaches, a group communication service or a one-to-one communication, is provided as a packet-based user or application level service so that the underlying communications system only provides the basic connections (i.e. IP connections) between the group communications applications in the user terminals and the group communication service. The group communication service can be provided by a group communication server system while the group client applications reside in the user equipments or terminals. Examples of this approach are disclosed in co-pending U.S. patent application Ser. Nos. 09/835,867; 09/903,871; and 10/160,272; and in WO 02/085051. When this approach is employed for the push-to-talk communication, the concept is also referred to as a Push-to-talk over Cellular (PoC).

Recently, number of companies has defined so called industry specifications for PoC solutions. These industry specifications describe also SIP session flows used in the PoC communication system. In the PoC communication system, the most critical end user requirement is delay. Therefore, the signalling flows should be designed so that delays are minimized. The above-mentioned industry specifications specify so called early media procedure. This procedure is illustrated in FIG. 2. In response to an establish-session-request 1 from a PoC application, user equipment (UE) sends a SIP INVITE request to the IMS core network which relays the SIP INVITE request to a PoC server. The IMS core network send also a 100 (Trying) response 2 back to the UE. The 100 (Trying) response indicates that the INVITE has been received and that the IMS core network is working on to route the INVITE to the destination. The PoC server sends a SIP 202 Accepted response 3 to the UE via the IMS core in order to indicate that a connection to a receiving party is being set up. SIP 202 Accepted contains the SDP payload. The SDP contains necessary media parameters for setup a media context (e.g. a packet data protocol PDP context) at an early stage before the receiving party has been connected. The purpose of the indication is that the UE could create a media context (e.g. a packet data protocol PDP context) at an early stage before the receiving party has been connected. The UE is supposed to acknowledge with a SIP ACK message 4. After the receiving party B has been connected, the PoC server indicates this with a SIP NOTIFY message 5 and the UE is supposed to acknowledge with a SIP 200 OK (NOTIFY) message 6.

However, the session flows according the industry specifications illustrated in FIG. 2 are not in conformance with IETF RFCs and 3GPP IMS principles. This incompatibility may introduce severe problems when the PoC is being specified in public standardisation bodies. It might be the case that the work cannot be progressed before the signalling diagrams are aligned with IETF SIP.

The main problems with the early media procedure shown in FIG. 2 are
The 202 Accepted—response does not have any meaning within the SIP INVITE method. The early media solution is relying on that the UE does not understand 202 response message and thus interprets the response as a 200 OK response.
An implicit subscription is not allowed as described in the flow (i.e. sending NOTIFY without subscription is not allowed). The implicit subscription is allowed with the REFER and SUBCRIBE methods.

Moreover, the early media procedure does not support a charging correlation procedure at all.

### DISCLOSURE OF THE INVENTION

An object of the invention is to provide an alternative approach for session establishment.

The object is achieved by the invention defined in the attached independent claims. Preferred embodiments of the invention are defined in the subclaims.

According to an embodiment of the invention, upon receiving an initial media session invitation request from a first media communication device, such as originating user equipment or an originating media communication server, a second media communication device, such as a media communication server responds to by sending a media inactivity indication to the first media communication device and setting the media inactive, while continuing the media session establishment at the same time. When the second media communication device receives a final response or a response from destination user equipment, the second media communication device sends a media activity indication to the first media communication device, thereby indicating that the media are now active. In an embodiment of the invention, when the second media communication device is able to buffer media streams it may send a media active indication prior to receiving a final response from the destination. When the media communication server is not able to buffer media streams or it is desirable to use the media active indication to indicate to the first media communication device that the destination user equipment has accepted the session initiation then the media active indication is sent when the second media communication device receives a final response. Standard messages can be used in their original context, while the use of the media inactivity and media activity control during the session establishment enables a controlled way to pre-establish the originating leg of the media session before the destination leg of the media session has been completed. The first media communication device will start sending media traffic only in a controlled manner either after receiving the media activity indication or after receiving a specific floor control command. In an embodiment of the invention, charging can be started by delivering a GPRS charging identity to the media communication server, when the originating user equipment sends an acknowledgement of the final message containing the media active indication.

In an embodiment of the invention, media traffic from the originating user equipment to the media communication server is initiated upon receiving said media session invitation response, and the media traffic may be buffered in the media communication server until receiving the media session establishment response from the destination user equipment. This further decrease the starting delay of the media traffic, such as delay of a first talk burst.

### BRIEF DESCRIPTION OF THE DRAWINGS

The above and other objects, features and advantages of the present invention will become more apparent in light of the following detailed description in conjunction with the drawings, in which

FIG. 1 illustrates a communication system having CS, PS and IMS core networks, and a PoC server,

FIG. 2 shows a flow diagram for the early media approach according to the prior art,

FIG. 3 shows a generic flow diagram for an embodiment of the invention,

FIGS. 4, 5 and 6 show example flow diagrams for three embodiments of the invention, and

FIGS. 7 and 8 show examples of session establishment in a system configuration having two media communication servers.

### DETAILED DESCRIPTION

The present invention is applicable to communications systems enabling real-time media sessions between end users. The real-time data may include real-time audio (e.g. speech), real-time video, or any other real-time data, or combination thereof, i.e. real-time multimedia.

The present invention is especially applicable to communications system allowing packet-mode real-time data communication, such as IP packet communication between end users. Thus, the real-time data communication may be carried out between end user terminals over the Internet, for example.

The present invention offers a significant improvement for packet-mode speech communications. Voice over Internet Protocol (VoIP) enables a speech communication over an IP connection. In some embodiments of the invention, the IP voice communication method employed is the Voice over IP (VoIP), but the invention is not limited to this particular method.

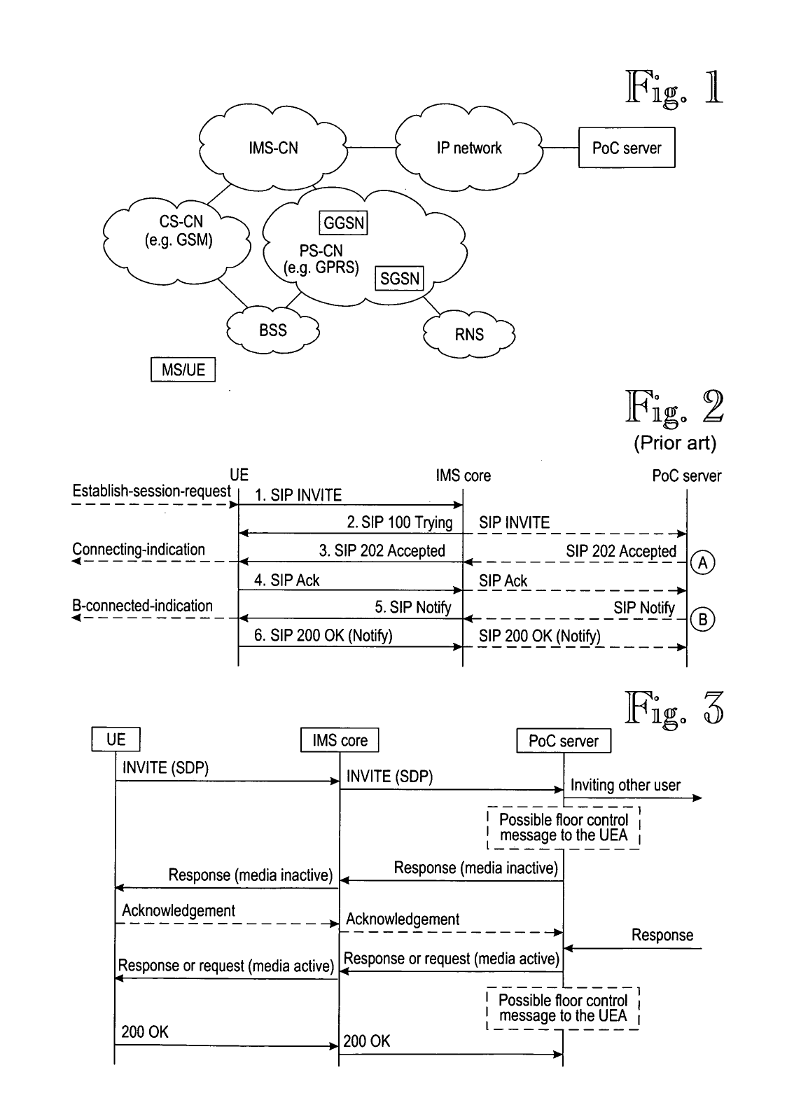

As an example of a system environment to which the principles of the present invention may be applied to will be described with reference to FIG. 1. In FIG. 1, a Push-to-talk Over Cellular (PoC) server system is provided on top of the IMS core network in order to provide a packet mode (e.g. IP) voice, data and/or multimedia communication services to the User Equipment (UE). An UE accessing the IM CN subsystem, and the IM CN subsystem itself, utilizes the services provided by GPRS to provide packet-mode communication between the UE and the IM CN subsystem. Requirements for the GPRS in support of this communication are specified in 3GPP TS 29.061 and 3GPP TS 29.207, for example.

Regarding to the PoC type services, examples of this concept are disclosed in co-pending U.S. patent application Ser. Nos. 09/835,867; 09/903,871; 10/160,272; and in WO 02/085051. Conceptually, a packet based media communication system is provided on top of the mobile network in order to provide media communication services to the user equipment UE through the communication system. The media communication system may be embodied as a server system, and it is generally referred to as a media communication server herein. The media communication server may comprise control-plane functions CPF and user-plane functions providing packet mode server applications that communicate with the communication client application(s) in the user equipment UE over the IP connections provided by the communication system. This communication includes signalling packets and voice or data communication packets. The CPF function is responsible for control-plane management of the group communication. This may include, for example, managing the user activity and creation and deletion of logical user-plane connections with an appropriate control protocol, such as Session Initiation Protocol (SIP). The user-plane function(s) UPF is responsible for distribution of the data or speech packets to the user terminals according to their group memberships and other settings. The UPF forwards traffic only between valid connections programmed by the CPF. In case of speech communication, it may be based on voice over IP (VoIP) protocol, and/or Real-time Transport Protocol (RTP). It should be appreciated that the user plane operation relating to the data or speech traffic is not relevant to the present invention. However, the basic operation typically includes that all the data or speech packet traffic from a sending user is routed to the UPF which then delivers the packet traffic to the receiving user(s).

In a GPRS environment, prior to communication with the IM CN subsystem, the UE a) performs a GPRS attach procedure, and b) establishes a PDP context (i.e. a bearer) used for SIP signaling. This PDP context will remain active throughout the period the UE is connected to the IM CN subsystem, i.e. from the initial registration and at least until deregistration. As a result, the PDP context provides the UE with information that makes the UE able to construct an IP address. During establishment of a session, the UE establishes data stream(s) for media related to the session. Such data stream(s) may result in activation of additional PDP context(s), i.e. bearers. Such additional PDP context(s) are established as secondary PDP contexts associated to the PDP context used for signalling. In other core network environments, other type of bearers may be used. It should be appreciated that the basic invention is basically independent from the type of the core network, although it provides essential advantages in association with IMS type core network.

It should be appreciated that there are many applications of the Internet world that require the creation and management of a session, where a session is considered an exchange of data between an association of participants. The implementation of these applications is complicated by the practices of participants: users may move between endpoints, they may be addressable by multiple names, and they may communicate in several different media—sometimes simultaneously. Therefore, the present invention is not restricted to PoC services but can be applied for media flow management of such other applications as well.

Numerous protocols have been authored that carry various forms of real-time multimedia session data such as voice, video, or text messages. The Session Initiation Protocol (SIP, RFC 3261) works in concert with these protocols by enabling Internet endpoints (called user agents) to discover one another and to agree on a characterization of a session they would like to share. For locating prospective session participants, and for other functions, SIP enables the creation of an infrastructure of network hosts (called proxy servers) to which user agents can send registrations, invitations to sessions, and other requests. SIP is an agile, general-purpose tool for creating, modifying, and terminating sessions that works independently of underlying transport protocols and without dependency on the type of session that is being established.

SIP is an application-layer control protocol that can establish, modify, and terminate multimedia sessions (conferences) such as Internet telephony calls. SIP can also invite participants to already existing sessions, such as multicast conferences. Media can be added to (and removed from) an existing session.

SIP is not a vertically integrated communications system. SIP is rather a component that can be used with other IETF protocols to build a complete multimedia architecture. Typically, these architectures will include protocols such as the Real-time Transport Protocol (RTP) (RFC 1889) for transporting real-time data and providing QoS feedback, the Real-Time streaming protocol (RTSP) (RFC 2326) for controlling delivery of streaming media, the Media Gateway Control Protocol (MEGACO) (RFC 3015) for controlling gateways to the Public Switched Telephone Network (PSTN), and the Session Description Protocol (SDP) (RFC 2327) for describing multimedia sessions. Therefore, SIP should be used in conjunction with other protocols in order to provide complete services to the users. However, the basic functionality and operation of SIP does not depend on any of these protocols.

SIP does not provide services. Rather, SIP provides primitives that can be used to implement different services. SIP does not offer conference control services such as floor control or voting and does not prescribe how a conference is to be managed.

SIP request is SIP message sent from a client to a server, for purpose of invoking a particular operation. SIP response is a SIP message sent from a server to a client, for indicating the status of a request sent from the client to the server.

SIP method is the primary function that a request is meant to invoke on a server. The method is carried in the request message itself. SIP contains primarily six methods: REGISTER for registering contact information, INVITE, ACK, and CANCEL for setting up sessions, BYE for terminating sessions, and OPTIONS for querying servers about their capabilities.

The most important method in SIP is the INVITE method, which is used to establish a session between participants. A session is a collection of participants, and streams of media between them, for the purposes of communication. UE initiates a call by generating an initial INVITE request.

There are various possible responses to the INVITE request. SIP responses are distinguished from requests by having a Status-Line as their start-line. A Status-Line consists of the protocol version followed by a numeric Status-Code and its associated textual phrase. The Status-Code is a 3-digit integer result code that indicates the outcome of an attempt to understand and satisfy a request. The Reason-Phrase is intended to give a short textual description of the Status-Code. The Status-Code is intended for use by automata, whereas the Reason-Phrase is intended for the human user. A client is not required to examine or display the Reason-Phrase.

The first digit of the Status-Code defines the class of response. The last two digits do not have any categorization role. For this reason, any response with a status code between 100 and 199 is referred to as a “1xx response”, any response with a status code between 200 and 299 as a “2xx response”, and so on. Currently, there are six values for the first digit but in the following examples only two of them are described:

Provisional responses 1XX, also known as informational responses, indicate that the server contacted is performing some further action and does not yet have a definitive response. A server sends a 1xx response if it expects to take more than a preset time to obtain a final response 1xx responses never cause the client to send an ACK.

100 Trying response indicates that the request has been received by the next-hop server and that some unspecified action is being taken on behalf of this call (for example, a database is being consulted). This response, like all other provisional responses, stops retransmissions of an INVITE by UE.

180 Ringing response may be used to initiate local ringback, when the UE receiving the INVITE is trying to alert the user.

A server may use a 181 Call Is Being Forwarded status code to indicate that the call is being forwarded to a different set of destinations.

182 Queued response may be used when the called party is temporarily unavailable, but the server has decided to queue the call rather than reject it.

183 (Session Progress) response is used to convey information about the progress of the call that is not otherwise classified. The Reason-Phrase, header fields, or message body may be used to convey more details about the call progress.

The second response class 2xx, Success, indicates the action was successfully received, understood, and accepted.

200 OK response indicates that the request has succeeded. The information returned with the response depends on the method used in the request.

The details of the session, such as the type of media, codec, or sampling rate, are not described using SIP. Rather, the body of a SIP message contains a description of the session, encoded in some other protocol format. One such format is the Session Description Protocol (SDP) (RFC 2327). This SDP message is carried by the SIP message in a way that is analogous to a document attachment being carried by an email message, or a web page being carried in an HTTP message.

In the Session Description Protocol (SDP), the session description may contain a number of media descriptions. Each media description starts with an “m=” field, and is terminated by either the next “m=” field or by the end of the session description.

The format of the SDP Media description may be as follows
m=(media name and transport address)
i=* (media title)
c=* (connection information—optional if included at session-level)
b=* (bandwidth information)
k=* (encryption key)
a=* (zero or more media attribute lines)

A media field may also have several sub-fields:
m=<media><port><transport><fmt list>

The first sub-field is the media type. Currently defined media include “audio”, “video”, “application”, “data” and “control”.

The second sub-field is the transport port to which the media stream will be sent. The meaning of the transport port depends on the network being used as specified in the relevant “c” field and on the transport protocol defined in the third sub-field. For some applications, it may be necessary to specify multiple transport ports. For RTP, only the even ports may used for data and the corresponding one-higher odd port may be used for RTCP. For example:
m=video 49170/2 RTP/AVP 31
   would specify that ports 49170 and 49171 form one RTP/RTCP pair and 49172 and 49173 form the second RTP/RTCP pair. RTP/AVP is the transport protocol and 31 is the format.

The third sub-field is the transport protocol. The fourth and subsequent sub-fields are media formats.

FIG. 3 shows a generic signalling flow diagram which illustrates, by means of an example, how the present invention may be implemented.

When the user equipment (UE) A desires to initiate a session (for example, audio, video, or a game), it formulates an INVITE request containing Session Description Protocol (SDP) elements, as discussed above. The INVITE request asks a server to establish a session with another user. The IMS core network forwards the INVITE request to the PoC server which further sends an invitation to the other user(s). There may be a floor control message (e.g. RTCP) from the PoC server to the UE A at this stage.

The PoC server also sends one of the appropriate response messages of the INVITE request to the UEA. Thus, the response message is in conformance with the relevant standards and appropriately recognised by the UE A. Moreover, in accordance with the principles of the present invention, the response (e.g. SIP 200 OK; or 183 Session Progress; or more generally, any 1xx response) contains a media inactive indication. Thus, the response on the first hand informs the UE A that the initial INVITE request was successful but, on the other hand, also sets the media(s) inactive at the same time. This prevents the UE A from sending media traffic towards the PoC server, even though a media bearer would be reserved. The UE A acknowledges the response as defined in relevant standards.

When the PoC Server receives a response to the INVITE request from the UE B, then the PoC Server sends either a request (e.g. UPDATE) or response (e.g. 200 OK) message with a media active indication to the UE A. The media active indication indicates that media(s) are now active.

It should be appreciated that the UE A is able to reserve its bearer (e.g. PDP context) when it has received media information from the PoC Server. In some embodiments of the invention, in order to minimize delays, the UE A may start reserving its bearer when it receives the first response (e.g. SIP 200 OK; or 183 Session Progress; or more generally, any 1xx response) with the media inactive indication from the PoC Server.

However, the UE A gets permission to send talk burst when it receives a floor control message (e.g. RTCP) that indicates possibility to send talk burst. It should be understood that there are possible combinations how the floor control message (e.g. floor granted) and the request (e.g. UPDATE) or response (e.g. 200) with the media active indication are sent to the UE A.

In a first example, the floor control message (e.g. floor granted) is sent before the other user B has been reached if the PoC Server is capable to buffer talk or data bursts. In this respect, the request (e.g. UPDATE) or response (e.g. 200) with the media active indication may be used to indicate that the user B has been successfully reached.

In a second example, the request (e.g. UPDATE) or response (e.g. 200) with the media active indication is sent as early as possible to the UE A, for instance when the first response is received from the user B. This would mean that UE A knows that media is active. The floor control message (e.g. floor granted) is sent when the PoC Server receives a final response from the UE B. This model could be used when the PoC Server is unable to buffer talk or data bursts.

Finally in FIG. 3, the UE A acknowledges the request or response message containing the media active indication.

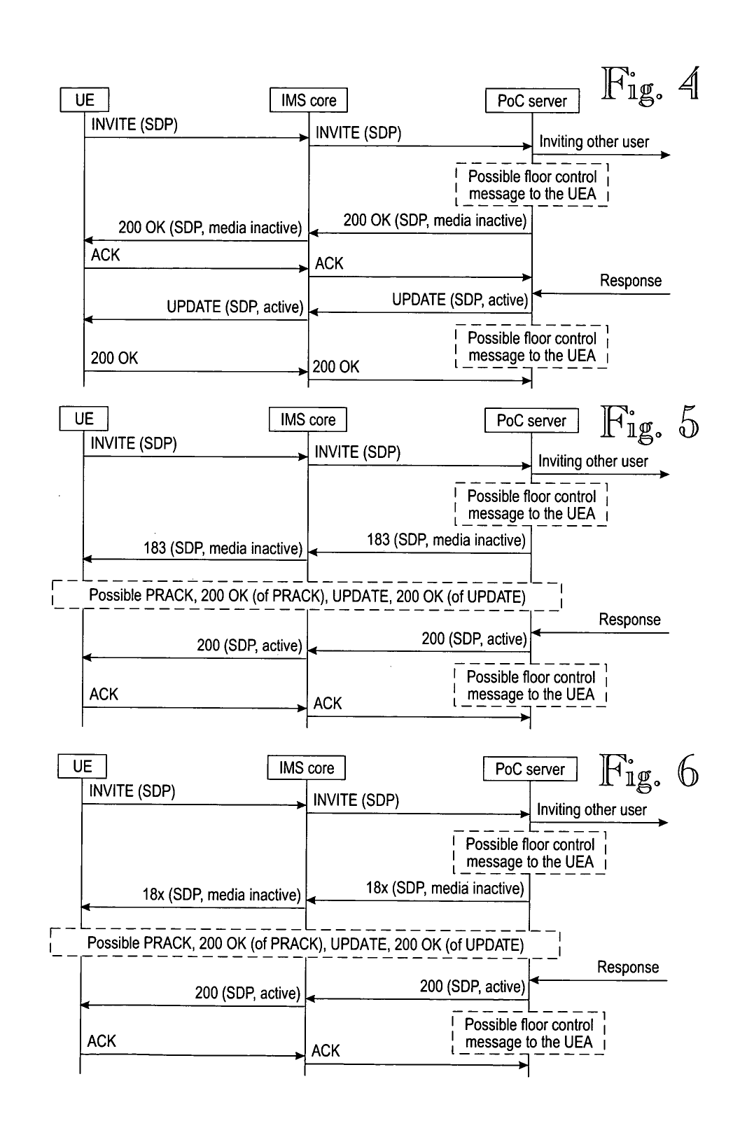

Examples of SIP signaling flows implementing the principles of the present invention will now be described with reference to FIGS. 4, 5, and 6.

In FIG. 4, when user equipment (UE) A desires to initiate a session, it formulates an INVITE request containing Session Description Protocol (SDP) elements, as discussed above. The INVITE request asks a server to establish a session with another user B. The IMS core network forwards the INVITE request to the PoC server which further sends an invitation to the other user(s). There may be a floor control message (e.g. RTCP) from the PoC server to the UE A at this stage.

When receiving the INVITE request from the UE A, the PoC server also sends a 200 OK containing a SDP element with a media inactive indication to the UEA, thereby preventing the UE A from sending media traffic towards the PoC server, even though a media bearer would be reserved. The UE A sends ACK request to acknowledge the 200 OK response.

When the PoC Server receives a final response from the user B, then the PoC Server sends an UPDATE request containing SDP element with a media active indication to the UE A, thereby indicating that the media is now active and the user B has accepted the session.

Similarly in FIG. 5, when a user equipment (UE) A desires to initiate a session, it formulates an INVITE request containing Session Description Protocol (SDP) elements, as discussed above. The INVITE request asks a server to establish a session with another user B. The IMS core network forwards the INVITE request to the PoC server which further sends an invitation to the other user(s). There may be a floor control message (e.g. RTCP) from the PoC server to the UE A at this stage.

When receiving the INVITE request from the UE A, the PoC server also sends a 183 Session Progress containing a SDP element with a media inactive indication to the UEA, thereby preventing the UE A from sending media traffic towards the PoC, even though a media bearer would be reserved.

At this stage there may possibly be other SIP signalling, such as PRACK request, 200 OK response of PRACK, UPDATE request, 200 OK response of UPDATE, etc. This signalling is not relevant to the present invention.

When the PoC Server receives a final response from the user B, then the PoC Server sends a 200 OK final response (of the initial INVITE request) containing SDP element with a media active indication to the UE A, thereby indicating that the media is now active and the user B has accepted the session.

In FIG. 6, when a user equipment (UE) A desires to initiate a session, it formulates an INVITE request containing Session Description Protocol (SDP) elements, as discussed above. The INVITE request asks a server to establish a session with another user B. The IMS core network forwards the INVITE request to the PoC server which further sends an invitation to the other user(s). There may be a floor control message (e.g. RTCP) from the PoC server to the UE A at this stage.

When receiving the INVITE request from the UE A, the PoC server also sends one of the 18x responses which could be defined for this purpose e.g. 184 Call in progress (HOLD) containing a SDP element with a media inactive indication to the UEA, thereby preventing the UE A from sending media traffic towards the PoC, even though a media bearer would be reserved.

At this stage there may possibly be other SIP signalling, such as PRACK request, 200 OK response of PRACK, UPDATE request, 200 OK response of UPDATE, etc. This signalling is not relevant to the present invention.

When the PoC Server receives a final response from the user B, then the PoC Server sends a 200 OK final response (of the initial INVITE request) containing SDP element with a media active indication to the UE A, thereby indicating that the media is now active.

In the embodiments of the invention, the SDP element providing the media inactivity indication and the media activity indication may be the second subfield, the transport port <port> in the media field. For example, value 0 may indicate that the media is still inactive, and other values may indicate that the media is active. Alternatively, other SDP elements may be used for purposes of media activity indication.

In an embodiment of the invention, a GPRS charging identity is delivered to the PoC Server when the UE A sends 200 OK to the UPDATE or ACK to the final response.

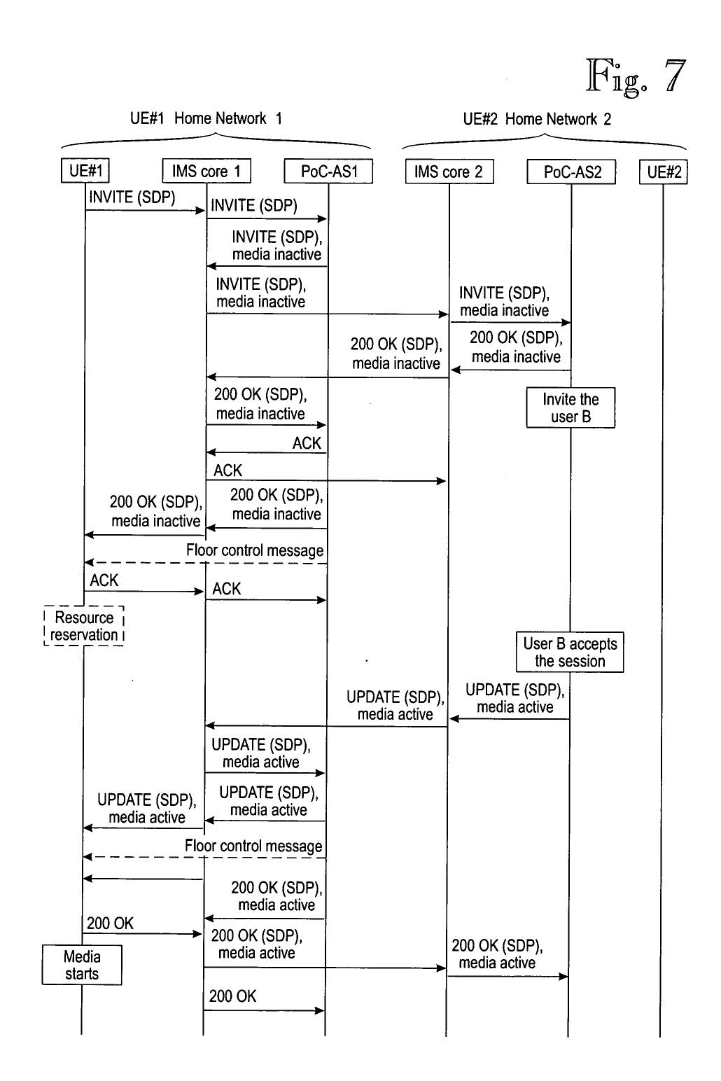

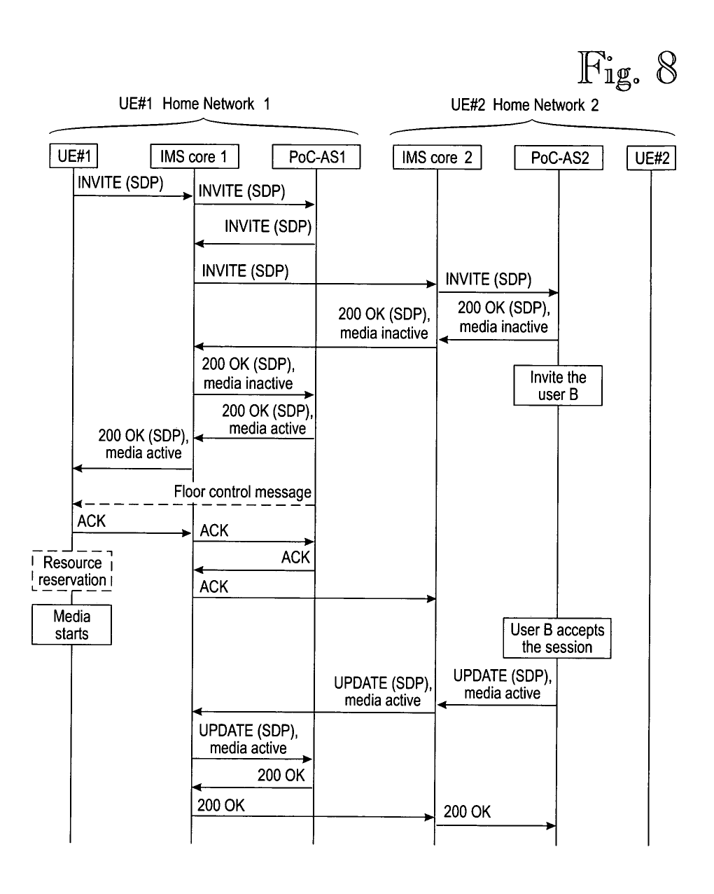

In the above examples, only the signaling between the originating user equipment and one media communication server has been described. However, in a multi-operator environment, for example, the destination user equipment may have a different media communication server, in this case the principles of the present invention may also be applied to the session establishment between the two servers. Two examples are now described with reference to FIGS. 7 and 8.

In the example of FIG. 7, first user equipment UE#1 is located in its home network 1 including an IMS core network 1 and a PoC server 1. Second user equipment UE#2 is located in its home network 2 including an IMS core network 2 and a PoC server 2. Let us first consider a case wherein neither of the PoC servers 1 and 2 is willing to buffer the media traffic during the session establishment. UE#1 sends an initial INVITE request to the PoC server 1 via the IMS core 1, e.g. in the manner described in the above examples. The PoC server 1 initiates a session establishment towards the destination user UE#2 by sending an INVITE request with a media inactive indication to the PoC server 2 via the IMS core networks 1 and 2. In response to receiving the inactivity indication, the PoC server 2 sets the direction PoC2-PoC1 inactive. The PoC server 2 sends a 200 OK response with a media inactive indication to the PoC server 1, in order to set also the other direction inactive. Having acknowledged this message, the PoC server sends a media inactive indication to the originating user equipment UE#1, e.g. in the way described in the above examples (in FIG. 7, 200 OK response is employed). As a result, required resources, e.g. a PDP context, are reserved but media traffic does not start. User B, i.e the UE#2, accepts the session to the PoC server 2 which sends an UPDATE request with a media active indication to the PoC server 1. The PoC server 1 sends an UPDATE request with media active indication to the originating UE#1, e.g. in the way described in the above examples after receiving a final response from the destination user (in FIG. 7, UPDATE request is employed. Also a floor control signaling allowing media traffic may be sent. The UE#1 sends a response, e.g. in the manner described in the above examples (in FIG. 7, 200 OK message is employed). Thus, the leg UE#1-PoC server 1 is active in both directions and media traffic can start. The PoC server 1 further sends a media active indication to the PoC server 2, e.g. in the 200 OK response. As a result, also the leg PoC server 1-PoC server 2 is active in both directions and media traffic can start also over this leg. The media active and inactive indications between the PoC servers may be provided in the similar manner described above with reference to FIGS. 3-6.

Also in the example of FIG. 8, first user equipment UE#1 is located in its home network 1 including an IMS core network 1 and a PoC server 1. Second user equipment UE#2 is located in its home network 2 including an IMS core network 2 and a PoC server 2. Let us now consider a case wherein the PoC server 1 is able to and the PoC server 2 is not able to buffer the media traffic during the session establishment. UE#1 sends an initial INVITE request to the PoC server 1 via the IMS core 1, e.g. in the manner described in the above examples. The PoC server 1 initiates a session establishment towards the destination user UE#2 by sending an INVITE request to the PoC server 2 via the IMS core networks 1 and 2. As the PoC server 2 is not willing to receive and buffer media traffic during the session establishment, it sends a 200 OK response with a media inactive indication to the PoC server 1, in order to set the leg inactive. As a result, the PoC server 1 will not forward media traffic to the PoC server 2 during session establishment.

However, since the PoC server is able to buffer media traffic, it sends a media active indication to the originating user equipment UE#1, e.g. in the way described in the above examples (in FIG. 8, 200 OK response is employed). Also a floor control signaling allowing media traffic may be sent. As a result, required resources, e.g. a PDP context, are reserved and media traffic can start. This session flow may be used for a “single server” case as an alternative to the examples shown in FIGS. 3 to 6.

User B, i.e. the UE#2, accepts the session to the PoC server 2 which sends an UPDATE request with a media active indication to the PoC server 1. The PoC server 1 acknowledges with a 200 OK response. As a result, also the leg PoC server 1-PoC server 2 is active in both directions and media traffic can start also over this leg. The media active and inactive indications between the PoC servers may be provided in the similar manner described above with reference to FIGS. 3-6.

This signalling scheme may raise a further problem how to inform the user A when the user B answers, since the media active indication has already been sent. One approach to solve this problem is that the PoC server 1 sends a further UPDATE request without SDP elements to the UE#1 when the PoC server 1 receives the UPDATE request with the media active indication from the POC server 2. Various embodiments of the invention have been described, but it will be appreciated by persons skilled in the art that these embodiments are merely illustrative and that many other embodiments are possible. The intended scope of the invention is set forth by the following claims, rather than the preceding description, and all variations that fall within the scope and spirit of the claims are intended to be embraced therein.

1. A method of establishing a media session, the method comprising:
sending a media session invitation request from a first media communication device to a second media communication device;
initiating a media session establishment from the second media communication device towards destination user equipment;
sending a first media inactivity indication from the second media communication device to the first media communication device; and
sending a first media activity indication from the second media communication device to the first media communication device, in response to receiving a media session establishment accepted response from the destination user equipment to the second media communication device.

2. A method according to claim 1, wherein
said first media communication device comprises a first media communication server,
said second media communication device comprises a second media communication server, and further comprising the steps of:
sending said media session invitation request from said first media communication server to said second media communication server in response to receiving another media session invitation request from originating user equipment;
sending a second media inactivity indication from the first media communication server to the originating user equipment in response to receiving said first media inactivity indication from the second media communication server;
sending a second media activity indication from the first media communication server to the originating user equipment in response to receiving said first media activity indication from said second media communication server.

3. A method according to claim 1, further comprising
sending, in association with said media session invitation request, a second media inactivity indication from said first media communication device to said second media communication device in response to receiving another media session invitation request from originating user equipment.

4. A method according to claim 1, wherein
said first media communication device comprises originating user equipment,
said second media communication device comprises a media communication server, and further comprising the steps of:
sending said first media inactivity indication from said media communication server to said originating user equipment in response to receiving said media session invitation request from said originating user equipment;
sending said first media activity indication from the media communication server to the originating user equipment in response to receiving said media session establishment accepted response from the destination user equipment.

5. A method according to claim 1, further comprising
sending said first media inactivity indication in a media session invitation response from said second media communication device to the first media communication device, and
sending said first media activity indication in a subsequent media request or session invitation response.

6. A method according to claim 5, wherein said sending step comprises sending said media session invitation request comprising a session initiation protocol INVITE request, and in which the media session invitation response comprises one of the following session initiation protocol responses:
OK;
provisional session progress; or
any provisional response.

7. A method according to claim 5, wherein the sending step comprises sending the subsequent media request or the session invitation response comprising one of the following:
a session initiation protocol UPDATE request; and
a session initiation protocol OK final response.

8. A method according to claim 5, further comprising providing said first media inactivity indication or said first media activity indication in a session description protocol media description field.

9. A method according to claim 1, further comprising
initiating media traffic from the first media communication device to the second media communication device upon receiving said media session invitation response,
buffering the media traffic in the second media communication device until receiving the media session establishment response from the destination user equipment.

10. A method according to claim 1, wherein said first sending step comprises sending said media session invitation request from said first media communication device to said second media communication device, in which the first or second media communication device comprises a packet mode voice communication server.

11. A communication system providing media sessions, the system comprising:
a first media communication device configured to send a media session invitation request;
a second media communication device configured to initiate a media session establishment towards a destination user equipment after receiving said media session invitation request;
said second media communication device configured to send a media inactivity indication to the first media communication device; and
said second media communication device configured to send a media activity indication to the first media communication device, upon receiving a media session establishment response from the destination user equipment to the second media communication device.

12. A communication system according to claim 11, wherein
said first media communication device comprises a first media communication server, and
said second media communication device comprises a second media communication server.

13. A communication system according to claim 11, wherein
said first media communication device comprises originating user equipment, and
said second media communication device comprises a media communication server.

14. A communication system according to claim 11, wherein said media session invitation request comprises a session initiation protocol INVITE request, and wherein the media inactivity indication is included in one of the following session initiation protocol responses:
OK;
provisional session progress; or
any provisional response, and
wherein the media activity indication is included in one of the following:
a session initiation protocol UPDATE request; and
a session initiation protocol OK final response.

15. A communication system according to claim 11, wherein said second media communication device is configured to provide said media inactivity indication or said media activity indication in a session description protocol media description field.

16. A communication system according to claim 13, comprising
said first user equipment configured to initiate media traffic to the media communication server upon receiving said media session invitation response,
said media communication server comprising a buffer buffering the media traffic in the media communication server until receiving the media session establishment response from the second user equipment.

17. A communication system according to claim 13, comprising
a internet protocol multimedia subsystem core network of a digital mobile communication network for providing bearer service for internet protocol based signalling and media traffic between the media communication server and the destination user equipment or originating user equipment.

18. A communication system according to claim 17, wherein said bearer service comprise at least one packet data protocol context.

19. A media communication server, comprising:
means for receiving a media session invitation request from originating user equipment or an originating media communication server;
means for initiating a media session establishment towards destination user equipment;
means for sending a media session invitation response containing a media inactivity indication to the originating user equipment or the originating media communication server; and
means for sending a request or a response containing a media activity indication to the originating user equipment or the originating media communication server, in response to receiving a media session establishment response from the destination user equipment.

20. A media communication server according to claim 19, further comprising
a buffer for buffering a media traffic received from the originating user equipment between sending of the media session invitation response and receiving of the media session establishment response from the destination user equipment.

21. A media communication server according to claim 19, wherein the media communication server comprises a packet mode voice communication server.

22. User equipment for a digital communication system, the user equipment comprising:
sending means for sending a media session invitation request to a media communication server,
first receiving means for receiving a media session invitation response containing a media inactivity indication from the media communication server, and
second receiving means for receiving a request or a response containing a media activity indication from the media communication server.

23. User equipment according to claim 22, wherein said media session invitation request comprises a session initiation protocol INVITE request, and the media session invitation response comprises one of the following session initiation protocol responses:
OK;
provisional session progress; or
any provisional response, and
wherein the request or the response containing a media activity indication comprises one of the following:
a session initiation protocol UPDATE request; and
a session initiation protocol OK final response.

24. User equipment according to claim 22, wherein a session description protocol media description field comprises said media inactivity indication or said media activity indication.

25. User equipment according to claim 22, further comprising
initiating means for initiating media traffic to the media communication server upon receiving said media session invitation response and a floor control message to be buffered in the media communication server until receiving the media session establishment response from the destination user equipment.

26. User equipment according to claim 22, wherein the user equipment comprises a packet mode voice communication client.

27. A system for establishing a media session, the system comprising:
first sending means for sending a media session invitation request from a first media communication device to a second media communication device;
initiating means for initiating a media session establishment from the second media communication device towards destination user equipment;
second sending means for sending a media inactivity indication from the second media communication device to the first media communication device; and
third sending means for sending a media activity indication from the second media communication device to the first media communication device, in response to receiving a media session establishment accepted response from the destination user equipment to the second media communication device.

28. A method according to claim 8, wherein said providing step further comprises providing said session description protocol media description field comprising a transport port subfield.

29. A method according to claim 10, wherein said sending step comprises sending said media session invitation request from said first media communication device to said second media communication device, in which the first or second media communication device comprises the packet mode voice communication server comprising a push-to-talk over cellular server.

30. A communication system according to claim 15, wherein said session description protocol media description field comprises a transport port subfield.

31. A media communication server according to claim 21, wherein the packet mode voice communication server comprises a push-to-talk over cellular server.

32. User equipment according to claim 24, wherein the session description protocol media description field comprises a transport port subfield.

33. User equipment according to claim 26, wherein the packet mode voice communication client comprises a push-to-talk over cellular client.
